(19) United States
(12) Patent Application Publication
(10) Pub. No.: US 2025/0149931 A1
(43) Pub. Date: May 8, 2025

(54) TAILORED PERMEABILITY MATERIALS

(71) Applicant: HORIZON TECHNOLOGY, St. Marys, PA (US)

(72) Inventors: Phillip McDonald, St. Marys, PA (US); Francis Hanejko, Marlton, NJ (US)

(21) Appl. No.: 18/837,550

(22) PCT Filed: Feb. 13, 2023
(86) PCT No.: PCT/US2023/012932

§ 371 Date: Aug. 9, 2024

Related U.S. Application Data
(60) Provisional application No. 63/309,215, filed on Feb. 11, 2022.

(51) Int. Cl. H02K 1/04; C08K 9/10

(52) U.S. Cl. CPC H02K 1/04; C08K 9/10

(57) ABSTRACT

A component for a motor or a generator may include a tailored permeability material having, based on total weight of the material, at least 10.0 percent volume of at least one metal material, up to 90.0 percent volume at least one binder, and a balance of incidental impurities. The tailored permeability material may be characterized by a permeability of at least 1.0 and a density of at least 2.0 g/cc³. Methods of manufacturing and uses of a tailored permeability material are also described.

### CROSS-REFERENCE TO RELATED APPLICATION

This application claims priority to and the benefit of U.S. Provisional Patent Application No. 63/309,215 filed on Feb. 11, 2022, entitled TAILORED PERMEABILITY MATERIALS, which is incorporated herein by reference in its entirety.

### FIELD OF THE INVENTION

This invention generally relates to systems and methods of making and using tailored permeability materials.

### BACKGROUND

Soft magnetic composite (SMC) materials are made from bonded iron powders. The iron powder may be coated with an insulating layer to provide high bulk electrical resistivity. SMCs may be used to provide materials with competitive magnetic properties, such as, good relative permeability and magnetic saturation, as well as high electrical resistivity, for example. These materials may be used in low loss applications, such as at high frequencies, for example, due to the high electrical resistivity. SMCs may provide certain advantages over conventional steel laminated materials, such as improved design, reduced cost, and less scrap during manufacturing. Accordingly, more efficient and/or cost-effective systems and methods of making and using SMC materials having tailored permeability materials may be desirable

### SUMMARY

The tailored permeability materials and methods of the present disclosure enable more efficient and/or cost-effective systems and methods of making and using tailored permeability materials.

The tailored permeability material of the present disclosure may comprise at least one metal material and a binder, wherein the binder may be a polymer.

The present disclosure is directed to methods of manufacturing a tailored permeability material.

The present disclosure is directed to uses of the tailored permeability material in at least one component of a motor or a generator.

### DESCRIPTION OF THE DRAWINGS

It is to be understood that both the foregoing summary and the following drawings and detailed description may be exemplary and may not be restrictive of the aspects of the present disclosure as claimed. Certain details may be set forth in order to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The present disclosure may be better understood by reference to the accompanying drawing sheets, in which:

FIG. 1A includes an illustration of a bobbin comprising a tailored permeability material according to the present disclosure.

FIG. 1B includes an illustration of a bobbin comprising a tailored permeability material according to the present disclosure wound with an electrically conductive wire.

FIG. 2 includes an illustration of an axial flux stator comprising a tailored permeability material according to the present disclosure.

FIG. 3A includes an illustration of a stator cap comprising a tailored permeability material according to the present disclosure.

FIG. 3B includes an illustration of a stator cap comprising a tailored permeability material according to the present disclosure placed on either end of a radial flux stator.

FIG. 3C includes an illustration of a stator cap comprising a tailored permeability material according to the present disclosure placed on either end of a radial flux stator and wound with an electrically conductive wire.

FIG. 3D includes an illustration of an air gap substantially filled with a tailored permeability material according to the present disclosure.

FIG. 4A includes an illustration of a stator tooth wedge comprising a tailored permeability material according to the present disclosure.

FIG. 4B includes an illustration of the stator tooth wedge of FIG. 4A surrounding one stator tooth.

FIG. 4C includes an illustration of the stator tooth wedge of FIG. 4A surrounding one stator tooth and placed over the tooth after electrically conductive wire is wound around the stator tooth.

FIG. 5A includes an illustration of a stator tooth cap comprising a tailored permeability material according to the present disclosure and configured to fill at least a portion of the gap between the two stator teeth or surround two stator teeth.

FIG. 5B includes an illustration of the stator tooth wedge of FIG. 4A surrounding stator teeth, wherein the stator tooth wedge surrounds the entire tooth.

FIG. 5C (FIG. 5B) includes an illustration of the stator tooth cap of FIG. 5A surrounding surround multiple teeth of a stator.

FIG. 6 includes an illustration of predicted permeability vs density and saturation induction vs density for a tailored permeability material according to the present disclosure.

FIG. 7 includes an illustration of measured induction vs applied field for a tailored permeability material according to the present disclosure.

### DETAILED DESCRIPTION

This disclosure generally describes systems and methods of making and using tailored permeability materials. It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations are intended to be included within the scope of this disclosure. As such, the claims may be amended to recite any features, aspects, and advantages expressly or inherently described in, or otherwise expressly or inherently supported by, this disclosure. Further, any features, aspects, and advantages that may be present in the prior art may be affirmatively disclaimed. Accordingly, this disclosure may comprise, consist of, consist essentially or be characterized by one or more of the features, aspects, and advantages described herein. As used herein, the term “and/or” includes any and all combinations of one or more of the associated listed items.

All numerical quantities stated herein are approximate, unless stated otherwise. Accordingly, the term “about” may be inferred when not expressly stated. The numerical quantities disclosed herein are to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values are reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges are continuous and include every value between the minimum and maximum values. Any maximum numerical limitation recited herein is intended to include all lower numerical limitations. Any minimum numerical limitation recited herein is intended to include all higher numerical limitations. Specific indications of ranges for upper and lower limits are for illustrative purposes and should not be understood to limit any possible sub-ranges contained therein, as indicated above.

In the following description, certain details are set forth in order to provide a better understanding of various features, aspects, and advantages the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The terminology used herein is for the purpose of describing particular examples only and is not intended to be limiting. As used herein, the singular forms “a”, “an”, and “the” may be intended to include the plural forms as well, unless the context clearly indicates otherwise. For example, “a component” may refer to more than one component. The terms “comprises”, “comprising”, “including”, “having”, and “characterized by”, are inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms are to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

As used herein, the term “motor” refers to any device that changes a form of energy into mechanical energy to produce motion. The term “motor” includes, but is not limited to, an axial flux motor, a radial flux motor, a direct current electromagnetic motor, an alternating current electromagnetic motor, an electric motor, a permanent magnet synchronous motor, and the like. The motor may be suitable for an automobile, truck, ship, plane or train.

As used herein, the term “generator” refers to any device that changes a form of mechanical energy to produce electrical force.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

A tailored permeability material according to the present disclosure may be used to direct magnetic flux with varying amounts of strength and may be made by injecting and/or compacting iron powder premixed with a polymer material. The mixture of iron powder and polymer material may comprise an iron particle to polymer ratio from 4:1 to 20:1. Such tailored permeability materials may be useful in alternating current or direct current electromagnetic motors to enhance the flow or redirection of magnetic flux. Tailored permeability materials may be used as an electrical insulator as well to safely create an insulation break between the electrical wire and the magnetically permeable and electrically conductive stator or rotor of a motor. Tailored permeability materials may be used in the manufacturing of components by a method of injection molding with an injection pressure of at least 50 MPa, by straight wall compaction molding having compaction pressures of at least 200 MPa, or by 3D printing, to create a material having a minimum permeability of 1, and a maximum permeability of 250. Thus, the tailored permeability material of the present disclosure may have a permeability of, without limitation, at least 1, such as at least 5, 10, 20, 30, 40, 50, 60, 70, 80, 90, 100, 120, 140, 160, 180, 200, or 220. The tailored permeability material may have a permeability of, without limitation, not more than 250, such as not more than 220, 200, 180, 160, 140, 120, 100, 90, 80, 70, 60, 50, 40, Or 20. Any combination of lower and upper limits may define the permeability of the tailored permeability materials of the present disclosure, such as 1 to 250, including, without limitation, 1 to 50, 1 to 100, 1 to 150, 1 to 200, 1 to 250, and 50 to 150.

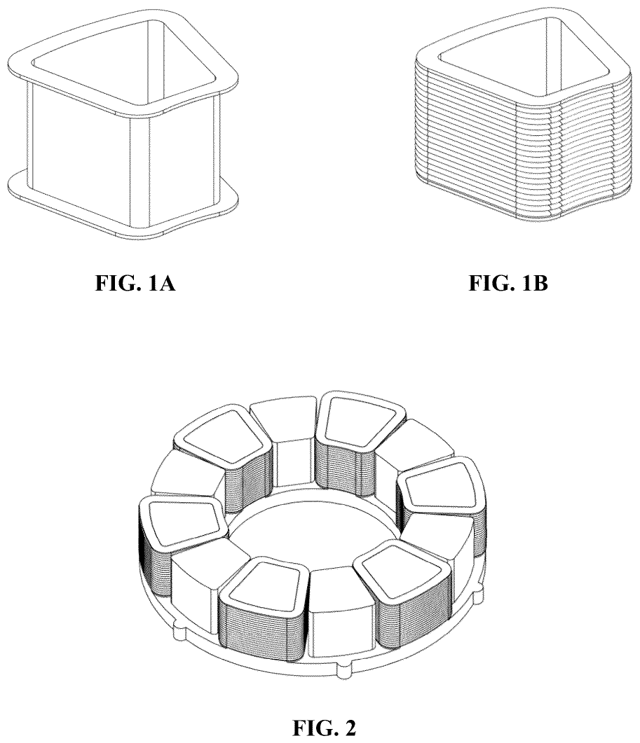

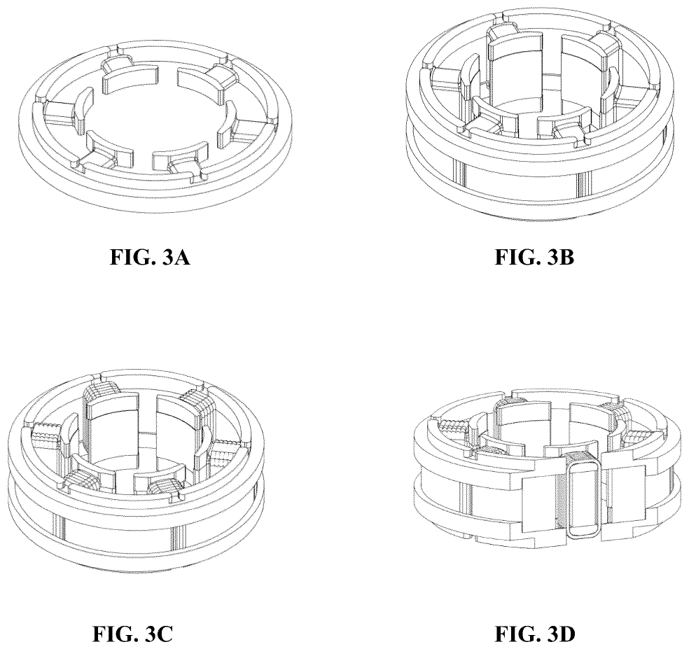

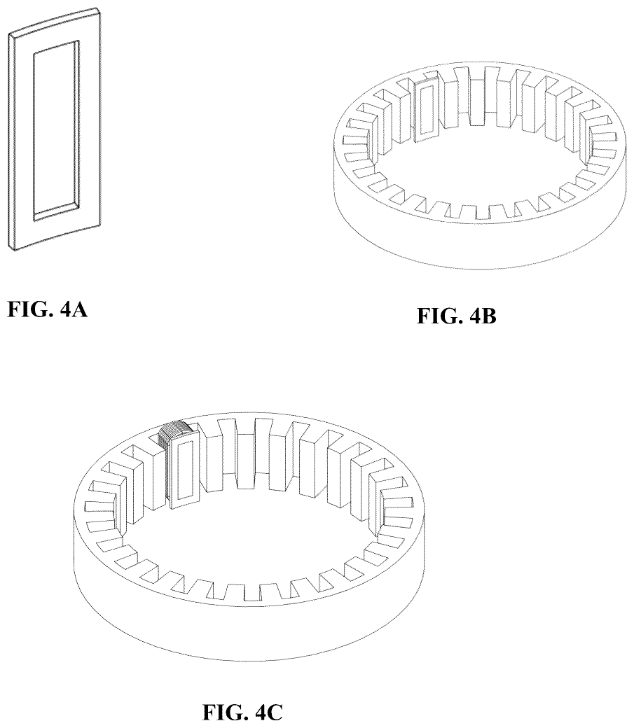

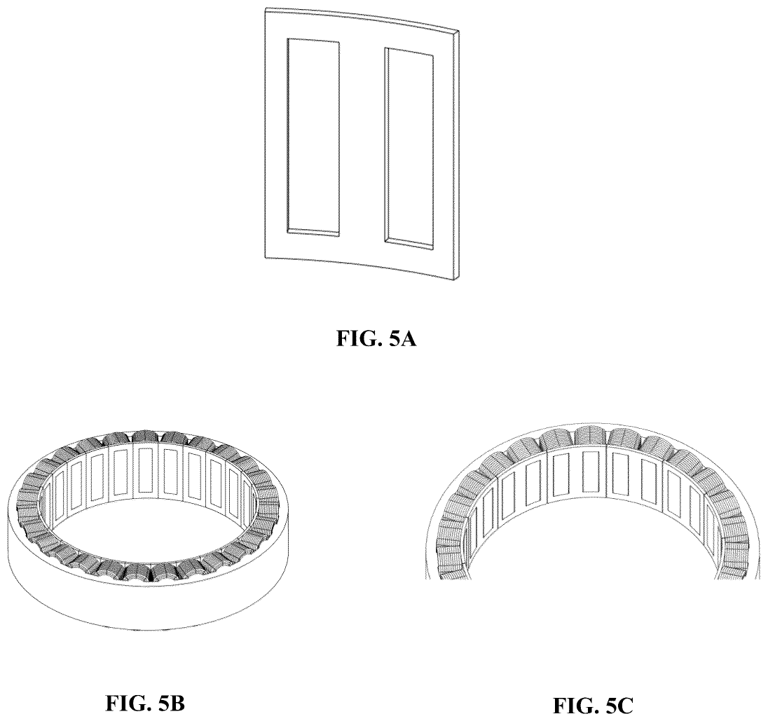

The tailored permeability material and methods described herein may be used in electromagnetic applications to steer, direct, and/or absorb magnetic flux. The tailored permeability material and processing described herein may be convenient and/or safe to use with injection molding, straight wall compaction molding, 3D printing and the like to provide components having customized magnetic permeability and/or saturation characteristics while providing net shape, or near net shape components for alternating current or direct current electromagnetic applications. The tailored permeability material and processing described herein may be used, but is not limited, to manufacture wire bobbins (FIGS. 1A and 1B), stator tooth caps (FIGS. 3A, 3B, 3C, 5A, 5B, and 5C), stator tooth wedges (FIGS. 4A, 4B, and 4C), and other components of a motor having a magnetic permeability from 1-250 Gauss (the unit of the B-field) and/or 1-250 Oersted (the unit of the H-field).

The tailored permeability material according to the present invention may be used to manufacture at least one component of a motor such as stator tooth end caps and wedges for a radial flux motor. The radial flux motor may include an air gap at the end of the stator tooth to facilitate the magnetic field to travel through the stator tooth, into the rotor, and back into an adjacent stator tooth, completing the magnetic circuit and creating torque on the rotor. A gap may be provided when winding the stator tooth with electrically conductive wire. In certain instances, a balanced approach may include creating a gap narrow enough to reduce the amount of energy needed to complete the magnetic circuit but large enough to include as much wire as possible. In certain instances, this gap may be larger than would be desirable for the motor performance to accommodate for easier winding techniques, such as slipping a pre-wound wire bobbin over the stator tooth rather than using a wire winding machine to wind the stator in place. The tailored permeability material may be used in conjunction with this type of motor manufacturing method to act as a stator tooth wedge or cap. This may fill in the air gap with a permeable material to lock the wire in place over the stator tooth and provide higher motor performance by shortening and/or eliminating the air gap between two stator teeth (FIG. 3D). When the permeability of the tailored permeability material is from 1-50, the air gap may be filled completely. Alternatively, when the permeability is from 50-250, a small air gap may be used to not fully complete the magnetic circuit which may cause lower motor performance if it short circuits the flux between two stator teeth rather than sending it through the rotor. This may shield the wire from direct electromagnetic flux being sent towards the wire in the case of a permanent magnet mounted rotor known as back EMF. This may reduce the amount of flux leakage and improve the magnetic saturation of the motor design.

The tailored permeability material may be used to manufacturer pre-wound bobbins (FIG. 1B). In certain axial flux motor designs, to reduce automation costs and streamline the motor assembly process, rather than using expensive winding equipment, pre-wound bobbins may be constructed and then slipped over the stator teeth to create the flux generating path. These bobbins may be constructed of a polymer core comprising at least one polymer described below having an electrically conductive wire wrapped around the outside. The polymer core may create a base structure to hold the wire in place and/or electrically insulate the wire from the stator to prevent electric shock when the wire insulation is damaged, for example, in assembly or during motor operation. A strictly polymer-based material may lack any magnetic performance. Instead, the strictly polymer-based material's polymer gap between the motor and wire may degrade motor performance. However, when this strictly polymer-based material is replaced with a tailored permeability material according to the present invention, the negative nature of the air gap may be reduced or eliminated by substituting a portion of the polymer with a high purity iron material, wherein high purity is at least 99% iron. Without wishing to be bound to any particular theory, it is believed that using the tailored permeability material in a motor application may provide certain advantages over strictly polymer-based materials by shortening the distance between each stator tooth, reducing back electromotive force (EMF), increasing the overall saturation, and/or reducing NVH (noise, vibration, harshness).

Back EMF is an electromotive force that opposes the applied voltage in a motor's coil and is proportional to the speed of the motor. The back EMF is created by the rotating magnetic field that is generated from magnets that are secured to the rotor in a permanent magnet synchronous motor. When the motor is running at a high speed, the back EMF increases, reducing the effective voltage across the coil and limiting the current flow, which in turn limits the torque generation capability of the motor. Thus, the back EMF is an important factor to be considered when designing a permanent magnet synchronous motor for high-torque applications. To increase the torque generation capability of the motor, it may be desirable to increase the voltage and/or use the tailored permeability material of the present disclosure to shield the coils from at least a portion of the induced voltage created by the rotating magnets of the permanent magnet synchronous motor.

The tailored permeability material may be used as at least one component of a motor, such as stator caps in radial flux motors (FIG. 3A), for example. In certain instances, a radial flux motor may have a stator created by stacking individual sheets of lamination steel. Conventional radial flux motors have been used for many years and may be an effective method of steering magnetic flux and reducing the amount of eddy current generation. However, this type of radial flux motor may suffer from the inherent two-dimensional geometry limitations in the direction the sheets of steel are stacked. When the wire is wrapped up and over the top of the stator tooth, there may be a sharp corner and an air gap. To eliminate the sharp corner that presents a potential for breaking the wire insulation, a plastic stator cap may be placed on the top and bottom face of the lamination stack. This creates a rounded surface for the wire to wrap over and acts as an insulation barrier to protect any wire damage from shorting out on the lamination stack. By replacing the plastic stator cap with a tailored permeability material of the present disclosure, the component may still have electrically insulating benefits while adding additional magnetic performance by filling the space that would be an air gap or a gap filled with non-permeable material with a magnetically permeable material to capture and/or steer and utilize the flux for torque generation with the wire passing over the end turn of the stator tooth (FIGS. 3C and 3D). Replacing components, such as a plastic stator cap with a tailored permeability material according to the present disclosure, for example, may reduce flux leakage from over saturation, reduce back EMF, and/or reduce NVH (i.e., noise, vibration, harshness).

The tailored permeability material according to the present disclosure may comprise a metal material and a binder. The metal material may comprise any magnetic material or ferromagnetic material including, but not limited to, iron, nickel, cobalt, and alloys utilizing any combination thereof, including, but not limited to, Permendur, an alloy of iron and nickel. The metal material may comprise magnetic ferrites, including, but not limited to, strontium ferrite, barium ferrite, manganese zinc ferrite, nickel zinc ferrite, cobalt zinc ferrite, copper zinc ferrite, iron nickel zinc ferrite, and other soft magnetic ferrites. The metal material may also comprise a metal-plastic composite material, comprising any metal material coupled with at least one polymer as described below. The metal material may comprise iron powder having, based on total weight of the iron powder, at least 90% iron, greater than 90% iron, at least 93% iron, at least 95% iron, at least 97% iron, at least 98% iron, and at least 99% iron.

The metal material may comprise magnetically permeable material. The metal material may be coated with a thin electrically insulating material comprised of a highly resistive oxide and/or ferrite before mixing or pelletizing the iron powder with the binder. The thin electrically insulating material may further reduce bulk electrical conductivity. The tailored permeability material may comprise one percent or less by weight volume of the thin electrically insulating material. The thin electrically insulating material may include, but is not limited to, phosphorous acid coating or a silicone coating. By varying the amount of metal material to the amount of the binder (e.g., a polymer as described below), the relative permeability may be tailored and customized for the desired magnetic performance. The tailored permeability material may be characterized by its permeability and minimal core losses due to the electrical insulation between the metal particles, such as iron, which may reduce eddy currents in the material. As used herein, the term “thin” refers to a thickness of 1 to 10 microns.

The binder may comprise a polymer. In some aspects, the binder may act as an insulator. The polymer may be characterized by its elasticity, mechanical strength, and/or thermal characteristics, which may be tailored and customized for the desired magnetic performance. The polymer may comprise low density polyethylene, high density polyethylene, polypropylene, polyvinyl chloride, polystyrene, nylon (polyamide), nylon 6,6, Teflon (polytetrafluoroethylene, thermoplastic polyurethanes, acrylics, phenol-formaldehyde resin, para-aramid, polychlorotrifluoroethylene, polychloroprene, copolyimide, polyimide, polytetrafluoroethylene (elastomer) or other such organic or inorganic compounds. In some aspects, the polymer is Nylon 6. Nylon 6 may be characterized by having high strength, ability to operate at high temperatures, and ability to hold a high amount of iron loading in the injection molding process.

The tailored permeability material may comprise a maximum of 90 percent by volume of the metal material. Thus, tailored permeability material may comprise a maximum 20, 30, 40, 50, 60, 70, 80, or 90 percent by volume and a minimum of 10, 20, 30, 40, 50, 60, 70, or 80 percent by volume of the metal material. The tailored permeability material may comprise at least 10 percent by volume of the metal material.

The tailored permeability material may comprise a maximum of 90 percent by volume of the binder. Thus, the tailored permeability material may comprise a maximum 20, 30, 40, 50, 60, 70, 80, or 90 percent by volume and a minimum of 10, 20, 30, 40, 50, 60, 70, or 80 percent by volume of the binder.

This disclosure describes a component for a motor or a generator comprising a tailored permeability material of the present disclosure. The tailored permeability material of the present disclosure may comprise at least 10 percent by volume of at least one metal material and up to 90 percent by volume of at least one binder. The tailored permeability material may include a balance of incidental impurities, including, but not limited to, carbon, oxygen, nitrogen, and other possible residuals of steel-making, including, but not limited to, manganese chromium, nickel, copper, and the like. The tailored permeability material of the present disclosure may be free, substantially free, essentially free, or completely free of the impurities. The permeability of the tailored permeability may be at least 1.0, and the density of the component may be at least 2.0 g/cc³.

The tailored permeability material according to the present disclosure may be made by a process that does not require any cutting or machining. The tailored permeability material may be manufactured consistently in an efficient manner without the need for labor intensive procedures. For example, the tailored permeability material may be injection molded, straight wall compaction molded, and/or 3D printed. In another example, the tailored permeability material may be cast in a mold for low volume prototyping needs.

A method for manufacturing a component comprising the tailored permeability material according to the present disclosure may generally comprise compacting an iron particle composition including a mixture of iron particles and a polymer binder under a pressure of at least about 50 MPA, including but not limited to, 40-45 MPA, 40-50 MPA, 40-55 MPA, and 40-60 MPA.

Without wishing to be bound to any particular theory, the permeability of the tailored permeability material may directly relate to the density of the tailored permeability material. For example, a tailored permeability material having 4.0 g/cc³ density may have 10 permeability. For example, a tailored permeability material having 3.7 g/cc³ may have 5 permeability. In other words, when the density increases, the permeability increases. The tailored permeability material may have a density from 2.0-4.5 g/cc³ when used in a metal injection molding process or 3D printing process to produce components having a permeability from 1-25. The component may comprise 5-20%, by weight of the component, of a polymer having certain mechanical properties, such as high ductility and elastic/stretching properties, to aid in the motor/generator assembly process. Components having a permeability from 1 to 25 may aid in adding saturation induction values and reducing back EMF into the wires while simplifying the assembly process of the motor. Exemplary components include a stator cap, a tooth wedge, a wire bobbin, and the like. These components may act as an insulation barrier between the electrically conductive wires and the motor stator.

A straight wall compaction method may be used to manufacture a tailored permeability material according to the present invention having a permeability of 25-100. Without wishing to be bound to any particular theory, it is believed that metal/polymer injection molding and 3D printing process may suffer from certain limitations when seeking to achieve a higher density component. In contrast, a method of manufacturing a higher density component may comprise mixing an iron powder and a polymer powder in a ratio effective to achieve the higher density, such as at least 2.0 g/cc³. After compaction, the component may go through an oven up to (at or below) the melting point of the polymer to achieve better mechanical bonding relative to the same component lacking this heating step. The iron/polymer powder may be compacted in a warm die having a temperature from 120-550° F. to achieve better mechanical bonding relative to the same component lacking this heating step.

The component may have a density up to 10 g/cc³. Thus, the component of the present disclosure may have a density of, without limitation, at least 1, such as at least 2, 3, 4, 5, 6, 7, 8, 9, or 10 g/cc³. The component may have a density of, without limitation, not more than 10, such as not more than 9, 8, 7, 6, 5, 4, 3, 2, or 1 g/cc³. Any combination of lower and upper limits may define the density of the component of the present disclosure, such as 1 to 10 g/cc³, including, without limitation, 1 to 5, 5 to 10, 2 to 8, 2 to 6, 6 to 10, and 8 to 10 g/cc³.

The iron powder may comprise a high purity iron powder having a lower coercivity and less energy to magnetize and de-magnetize to improve the efficiency of the electric motor.

The particle size of the iron powder may comprise a larger particle size, a medium particle size, a small particle size, or a distribution of small, medium, and large for certain applications. As used herein, a large particle is 200 to 400 microns, a medium particle is 51 to 200 microns, and a small particle is 0.5 to 50 microns. For example, a small particle size may be selected when the operating frequency of the electromagnetic device is above 1000 Hz. A large particle size may be selected when the operating frequency is below 1000 Hz. A particle distribution may be selected with the majority being large particles and a small fraction of small particles to achieve a high density when a higher permeability is desired. A specific particle size may be selected to effectively dampen specific frequencies by creating high eddy currents at those specific frequencies. The particle distribution may comprise large particles and be free, substantially free, essentially free, or completely free of medium particle and small particles. The particle distribution may comprise large particles and medium particles and be free, substantially free, essentially free, or completely free of small particles. The particle distribution may comprise small particles and be free, substantially free, essentially free, or completely free of medium particle and large particles. The particle distribution may comprise small particles and medium particles and be free, substantially free, essentially free, or completely free of large particles. As generally used herein, the phrase “free” refers to having 20 vol. % or less, “substantially free” refers to having 10 vol. % or less, “essentially free” means less than 5 vol. % and “completely free” means less than 1 vol. %.

### EXAMPLES

Example 1: A tailored permeability material of the present disclosure comprising iron and polycaprolactam (referred to as Nylon 6) is made by mixing iron particles and a polycaprolactam particles and compacting the mixture under a pressure of at least about 50 MPA. Based on the total volume of the material, the iron is 70 volume % (5.495 grams) with a density of 7.85 g/cc³ and the Nylon 6 is 30 volume % (0.342 grams) with a density of 1.14 g/cc³. The total weight of the tailored permeability material is 5.837 grams, and the component of a motor comprising the tailored permeability material has a density of 5.837 g/cc³.

Example 2: A tailored permeability material of the present disclosure comprising iron and Nylon 6 is made by mixing iron particles and a polycaprolactam particles and compacting the mixture under a pressure of at least about 50 MPA. Based on the total volume of the material, the iron is 50 volume % (3.925 grams) with a density of 7.85 g/cc³ and the Nylon 6 is 50 volume % (0.57 grams) with a density of 1.14 g/cc³. The total weight of the tailored permeability material is 4.495 grams, and the component of a motor comprising the tailored permeability material has a density of 4.495 g/cc³.

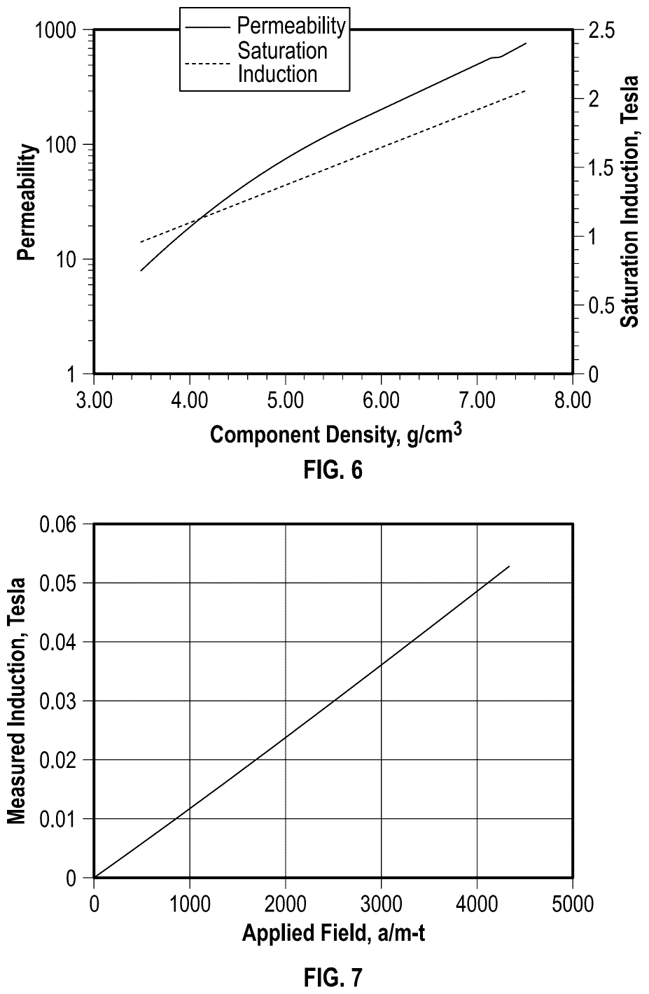

Example 3: FIG. 6 shows a predicted permeability of about 7 at 3.6 g/cc³ and about 800 at 7.6 g/cc³, and a predicted saturation induction of about 1 and about 2.1. Referring to FIG. 7, the measured induction of 4.2 g/cm³ of a tailored permeability material of the present disclosure at 4000 a/m-t is 0.048 Tesla. As shown in FIG. 7, the measured induction is linear from 0 to 4000 a/m-t. Without wishing to be bound to any particular theory, is it believe that the permeability is on the order of 9/10. The permeability may be calculated by dividing the induction by the applied field in Oersted as follows:

$$Permeability = \frac{480 ( gauss )}{4000 ( \text{a/m-t} )} \times 79.5 ( conversion of \text{a/m-t} to Oe ) = 9.5 .$$

The following aspects are disclosed in this application:

Aspect 1: A component for a motor comprising a tailored permeability material, wherein the tailored permeability material having a composition of at least 10.0 percent volume at least one metal material, up to 90.0 percent volume at least one binder, and a balance of incidental impurities, wherein the tailored permeability material characterized by a permeability of at least 1.0, and wherein the component characterized by a density of at least 2.0 g/cc³.

Aspect 2: The component of aspect 1, wherein the metal material is iron powder.

Aspect 3: The component of any of the foregoing aspects, wherein the metal material is coated with an electrically resistant coating, the tailored permeability material having less than 1.0 percent volume of the electrically resistant coating.

Aspect 4: The component of any of the foregoing aspects, wherein the binder is a polymer.

Aspect 5: The component of any of the foregoing aspects, wherein the polymer is Nylon 6.

Aspect 6: The component of any of the foregoing aspects, wherein the motor is a radial flux motor.

Aspect 7: The component of any of the foregoing aspects, wherein the component is a base for pre-wound bobbins.

Aspect 8: The component of any of the foregoing aspects, wherein the component is a stator cap.

Aspect 9: The component of any of the foregoing aspects, wherein the component is a stator tooth wedge.

Aspect 10: The component of any of the foregoing aspects, wherein the tailored permeability material characterized by a permeability selected from 1-100, 1-25, and 25-100.

Aspect 11: The component of any of the foregoing aspects, wherein the motor is an alternating current electric motor.

Aspect 12: The component of any of the foregoing aspects, wherein the tailored permeability material configured to reduce noise, vibration, and harshness in the alternating current electric motor.

Aspect 13: The component of any of the foregoing aspects, wherein the tailored permeability material configured to reduce back electromagnetic flux in the alternating current electric motor.

Aspect 14: The component of any of the foregoing aspects, wherein the tailored permeability material configured in an alternating current electromagnetic motor to increase flow and/or redirection of magnetic flux.

Aspect 15: The component of any of the foregoing aspects, wherein the tailored permeability material configured in a direct current electromagnetic motor to increase flow and/or redirection of magnetic flux.

Aspect 16: The component of any of the foregoing aspects, wherein the tailored permeability material is an electrical insulator, wherein the tailored permeability material creates an insulation break between an electrical wire and a magnetically permeable and electrically conductive stator or rotor of a motor.

Aspect 17: The component of any of the foregoing aspects, wherein the tailored permeability material shields coils from induced voltage generated by the permanent magnet synchronous motor.

Aspect 18: The component of any of the foregoing aspects, wherein the tailored permeability material shields back electromagnetic flux from the motor.

Aspect 19: The component of any of the foregoing aspects, wherein the tailored permeability material transmits electromagnetic flux.

Aspect 20: The component of any of the foregoing aspects, wherein the motor is one of a radial flux motor; and an alternating current electric motor.

Aspect 21: The component of any of the foregoing aspects, wherein the motor, relative to a motor lacking the tailored permeability material, is characterized by at least one of reduced noise, vibration, and harshness; reduced back electromagnetic flux; and increased flow and/or redirection of magnetic flux.

Aspect 22: A method of manufacturing a tailored permeability material, the method comprising: compacting an iron powder composition comprising a mixture of iron particles and a polymer material under a pressure of at least 50 Mpa in a mold to produce a component to be used in conjunction with an electric motor stator and windings.

Aspect 23: The method of aspect 22, wherein the polymer material is Nylon 6.

Aspect 24: The method of any of the foregoing aspects, wherein compacting comprises a straight wall compacting having a pressure of at least 250 MPa.

Aspect 25: The method of any of the foregoing aspects, wherein the mixture comprises an iron particle to polymer ratio from 4:1 to 20:1.

Aspect 26: The method of any of the foregoing aspects, wherein compacting comprises at least one of an injection molding process and 3-dimensional printing.

Aspect 27: The method of any of the foregoing aspects, wherein the tailored permeability material comprises a magnetic permeability selected from 1-100, 1-25, and 25-100.

Aspect 28: A component for a motor selected from the group consisting of a base for pre-wound bobbins, a stator cap, a stator tooth wedge, a stator, and a rotor, comprising: a tailored permeability material comprising, based on total volume of the tailored permeability material, at least 10.0 percent volume at least one metal material, up to 90.0 percent volume at least one binder, and a balance of incidental impurities, wherein the tailored permeability material is characterized by a permeability of at least 1.0, and wherein the component is characterized by a density of at least 2.0 g/cc³.

Aspect 29: A component for a generator comprising: a tailored permeability material comprising, based on total volume of the tailored permeability material, at least 10.0 percent volume at least one metal material, up to 90.0 percent volume at least one binder, and a balance of incidental impurities, wherein the tailored permeability material is characterized by a permeability of at least 1.0, and wherein the component is characterized by a density of at least 2.0 g/cc³.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that are within the scope of this application.

1. A component for a motor selected from the group consisting of a base for pre-wound bobbins, a stator cap, a stator tooth wedge, a stator, and a rotor, the component comprising:
a tailored permeability material comprising, based on total volume of the tailored permeability material
at least 10.0 percent volume at least one metal material,
up to 90.0 percent volume at least one binder, and
a balance of incidental impurities,
wherein the tailored permeability material is characterized by a permeability of at least 1.0, and
wherein the component is characterized by a density of at least 2.0 g/cc³.

2. The component of claim 1, wherein the tailored permeability material characterized by a permeability selected from 1-100, 1-25, and 25-100.

3. The component of claim 1, wherein the metal material is iron powder.

4. The component of claim 1, wherein the metal material is coated with an electrically resistant coating, wherein the tailored permeability material having less than 1.0 percent volume of the electrically resistant coating.

5. The component of claim 1, wherein the binder is a polymer.

6. The component of claim 5, wherein the polymer is Nylon 6.

7. The component of claim 1, wherein the motor is one of
a radial flux motor; and
an alternating current electric motor.

8. The component of claim 7, wherein the motor, relative to a motor lacking the tailored permeability material, is characterized by at least one of
reduced noise, vibration, and harshness;
reduced back electromagnetic flux; and
increased flow and/or redirection of magnetic flux.

9. The component of claim 1, wherein the tailored permeability material is an electrical insulator to create an insulation break between an electrical wire and a magnetically permeable and electrically conductive stator or rotor of a motor.

10. The component of claim 1, wherein the tailored permeability material shields back electromagnetic flux from the motor.

11. The component of claim 1, wherein the tailored permeability material transmits electromagnetic flux.

12. A permanent magnet synchronous motor comprising the component to claim 1, wherein the tailored permeability material shields coils from induced voltage generated by the permanent magnet synchronous motor.

13. A method of manufacturing a tailored permeability material, the method comprising:
compacting an iron powder composition comprising a mixture of iron particles and a polymer material under a pressure of at least 50 Mpa in a mold to produce a component to be used in conjunction with an electric motor stator and windings.

14. The method of claim 13, wherein compacting comprises a straight wall compacting having a pressure of at least 250 MPa.

15. The method of claim 11, wherein the mixture comprises an iron particle to polymer ratio from 4:1 to 20:1.

16. The method of claim 13, wherein the tailored permeability material comprises a magnetic permeability selected from 1-100, 1-25, and 25-100.

17. A component for a generator comprising:
a tailored permeability material comprising, based on total volume of the tailored permeability material
at least 10.0 percent volume at least one metal material,
up to 90.0 percent volume at least one binder, and
a balance of incidental impurities,
wherein the tailored permeability material is characterized by a permeability of at least 1.0, and
wherein the component is characterized by a density of at least 2.0 g/cc³.
